(19) United States
(12) Patent Application Publication
(10) Pub. No.: US 2009/0280008 A1
(43) Pub. Date: Nov. 12, 2009

(54) VORTICITY REDUCING COWLING FOR A DIFFUSER AUGMENTED WIND TURBINE ASSEMBLY

(76) Inventor: Gerald E. Brock, Livonia, NY (US)

Correspondence Address: Woods Oviatt Gilman LLP, 700 Crossroads Bldg, 2 State St., Rochester, NY, 14614, US

(21) Appl. No.: 12/502,716

(22) Filed: Jul. 14, 2009

Related U.S. Application Data
(63) Continuation-in-part of application No. 12/009,057, filed on Jan. 16, 2008.

(51) Int. Cl. F03D 1/04

(52) U.S. Cl. 415/208.2

(57) ABSTRACT

A vorticity reducing cowling for a diffuser augmented wind turbine assembly is provided. The diffuser augmented wind turbine assembly includes a shroud, a wind turbine disposed within the shroud, and a diffuser coupled to an outlet of the shroud. The wind turbine includes a wind turbine housing and a plurality of blades rotatably disposed within the wind turbine housing, wherein the plurality of blades providing a swept area. The cowling comprises a body disposed upstream of the plurality of blades. The body includes an inlet end defining a first opening, the first opening having a first area. The body includes an outlet end defining a second opening, the second opening having a second area that is less that the first area. The second area is less than the swept area of the plurality of the blades.

### CROSS-REFERENCE TO RELATED APPLICATIONS

This application is a continuation-in-part of U.S. patent application Ser. No. 12/009,057, which was filed on Jan. 16, 2008. The contents of U.S. patent application Ser. No. 12/009,057 is hereby incorporated by reference in its entirety.

### FIELD OF THE INVENTION

The present invention relates to a vorticity reducing cowling for a diffuser augmented wind turbine assembly; more particularly, to a cowling that reduces the vorticity of the air flowing into a wind turbine assembly, while increasing the laminar flow of the air flowing therethrough, which results in a more efficient diffuser augmented wind turbine assembly.

### BACKGROUND OF THE INVENTION

Diffuser augmented wind turbine assemblies are known in the art. These prior art assemblies typically include a housing with a diffuser coupled with the outlet end of the housing, and a rotor positioned within the housing. The rotor typically includes a plurality of blades that are rotatably positioned within the housing, which are rotated by the wind and used to generate usable energy.

Two examples of prior art diffuser augmented wind turbine assemblies are shown in U.S. Pat. No. 7,218,011 and U.S. Pat. No. 4,075,500. Both of these diffuser augmented wind turbine assemblies suffer from a number of drawbacks and deficiencies. One problem encountered by the assemblies described in these two patents relates to blade tip vorticity. Vorticity, for fluid flow, is defined as a vector equal to the curl of the velocity of flow. In the context of a wind turbine, this specifically relates to wind flowing into the housing of the assembly and around the tip of the blades, which prevents the blades from rotating in an efficient manner, thereby reducing the efficiency of the wind turbine. In both of the assemblies shown and described in the above-noted patents, air enters the inlet end of the housing, and nothing prevents the air from flowing around the tips of the blades. Therefore, these assemblies do not acknowledge or otherwise provide an effective solution for reducing blade tip vorticity.

One aspect of this invention to provide an improved diffuser augmented wind turbine assembly that is more efficient than the prior art diffuser augmented wind turbine assemblies.

### SUMMARY OF THE INVENTION

The present invention is directed to a vorticity reducing cowling for a diffuser augmented wind turbine assembly. The diffuser augmented wind turbine assembly includes a shroud, a wind turbine disposed within the shroud, and a diffuser coupled to an outlet of the shroud. The wind turbine includes a wind turbine housing and a plurality of blades rotatably disposed within the wind turbine housing, wherein the plurality of blades providing a swept area. The cowling comprises a body disposed upstream of the plurality of blades. The body includes an inlet end defining a first opening, wherein the first opening has a first area. The body includes an outlet end defining a second opening, wherein the second opening has a second area that is less that the first area. The second area is less than the swept area of the plurality of the blades. The second opening and the swept area may be circular so that each has a diameter, wherein the diameter of the second opening is less than the diameter of the swept area. Further, the diameter of the second opening and the diameter of the swept area may be concentrically disposed relative to one another.

The cowling may further include a plurality of radially disposed stator members coupled with the cowling body. The radial stator members may be planar and disposed parallel with a longitudinal axis of the wind turbine. Furthermore, a cone diffuser may be coupled with the radial stator members and disposed on a longitudinal axis of the wind turbine. The cowling may also include at least one lateral stator member that is coupled to two of the radial stator members, wherein at least one lateral stator member may be coupled to a midpoint of the radial stator members. The lateral stator members may be planar and parallel with a longitudinal axis of the wind turbine.

The present invention is also directed to a diffuser augmented wind turbine assembly comprising a shroud including an inlet end and an outlet end, and a plurality of blades rotatably disposed within the shroud, wherein the plurality of blades providing a swept area. The diffuser augmented wind turbine assembly further including a diffuser coupled to the outlet end of the shroud, and a cowling coupled with the inlet end of the shroud. The cowling may be configured as described above. In addition, the shroud includes an exhaust chamber, wherein the diffuser augmented wind turbine assembly includes means for directing a first fluid towards the plurality of blades, means for directing a second fluid around the shroud without contacting the plurality of blades, means for combining the first fluid and the second fluid in the exhaust chamber, and means for creating a vacuum in the exhaust chamber.

### BRIEF SUMMARY OF THE SEVERAL VIEWS OF THE DRAWINGS

The present invention will now be described, by way of example, with reference to the accompanying drawings, in which:

FIG. 1 is a perspective view of a diffuser augmented wind turbine assembly;

FIG. 2 is an exploded perspective view of the assembly of FIG. 1;

FIG. 3 is a perspective view of housing used in the apparatus depicted in FIG. 1;

FIG. 4 is a perspective view of a wind turbine assembly;

FIG. 5 is an exploded perspective view of the wind turbine assembly depicted in FIG. 4;

FIG. 6 is a sectional side view of the assembly of FIG. 1;

FIG. 7 is a side sectional view of the wind turbine assembly depicted in FIG. 4;

FIG. 8 is a side schematic view of a rotor blade tip vorticity reducer;

FIG. 9 is a perspective front view of the vorticity reducer depicted in FIG. 8;

FIG. 10 is a perspective view of a wind suppressor inlet assembly;

FIG. 11 is a front view of the suppressor inlet assembly depicted in FIG. 10;

FIG. 12 is a front view of a rotor including different sized blades;

FIG. 13A is a front view of a first blade used with the rotor depicted in FIG. 12;

FIG. 13B is a front view of a second blade used with the rotor depicted in FIG. 12;

FIG. 13C is a front view of a third blade used with the rotor depicted in FIG. 12;

FIG. 14 is a perspective view of a second embodiment of a rotor blade tip vorticity reducer;

FIG. 15 is a front view of the vorticity reducer shown in FIG. 14;

FIG. 16 is a perspective view of a third embodiment of a rotor blade tip vorticity reducer;

FIG. 17 is a front view of the vorticity reducer shown in FIG. 16;

FIG. 18 is a perspective view of a second embodiment of a diffuser augmented wind turbine assembly;

FIG. 19 is a front view of the diffuser augmented wind turbine assembly shown in FIG. 18;

FIG. 20 is a perspective view of the diffuser augmented wind turbine assembly shown in FIG. 18 with a portion of a diffuser broken away; and

FIG. 21 is a cross-sectional view of the diffuser augmented wind turbine assembly shown in FIG. 19 taken along line 21-21.

Corresponding reference characters indicate corresponding parts throughout the several views. The exemplification set out herein illustrates embodiments of the invention, and such exemplifications are not to be construed as limiting the scope of the invention in any manner.

### DETAILED DESCRIPTION OF THE INVENTION

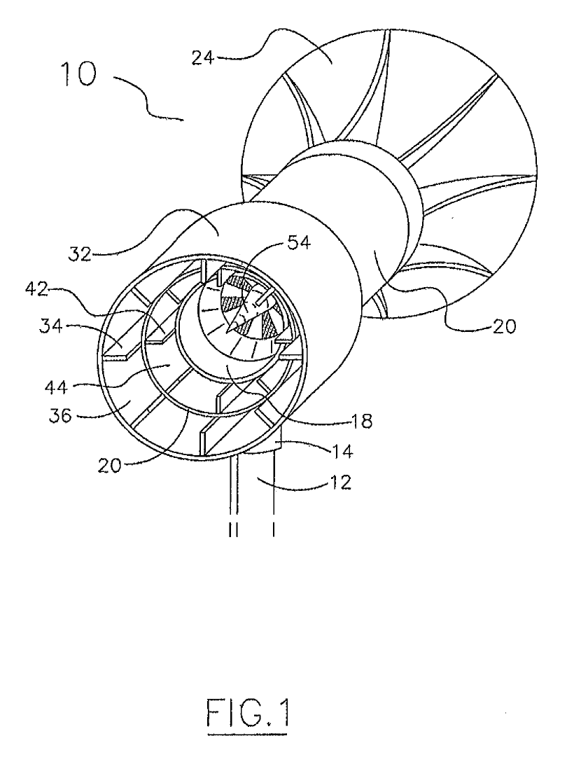

FIG. 1 is a schematic view of a diffuser augmented wind turbine assembly 10 that is mounted on a support 12. The support 12 may be connected, e.g., to a fixed structure (such as the ground, a building, a carriage assembly) and/or to movable structure. In one preferred embodiment, the support 12 is rotatably connected to assembly 10 so that the assembly 10 can rotate (or be rotated). In another embodiment, the support 12 is fixedly connected to assembly 10.

In one embodiment, not shown, a yaw motor is operatively connected to the assembly 10 to rotate it.

In one embodiment, the support structure depicted in U.S. Pat. No. 4,075,500 by reference to elements 24, 26, and 28 may be used. At column 4 of this patent, e.g., it disclosed that “The duct or shroud 18 is mounted by a mast 24 to a rotatable joint 26 on a tower 28 so as to be selfcocking into the direction of the wind.” Such an assembly could be used in connection with assembly 10.

In another embodiment, the support structure depicted U.S. Pat. No. 7,218,011 by elements 11 and 12 may be utilized. As is disclosed in column 1 of such patent, “FIG. 1 shows a diffuser augmented wind-turbine assembly 10 rotatably mounted on a conventional support pole 11 so that it can be moved by a find 12 to compensate for shifting wind directions.

Referring again to FIG. 1, and to the embodiment depicted therein, it will be seen that support 12 is disposed within sleeve 14. In one embodiment, bearings (not shown) are disposed within sleeve 14 to facilitate the rotation of support 12 within such sleeve 14.

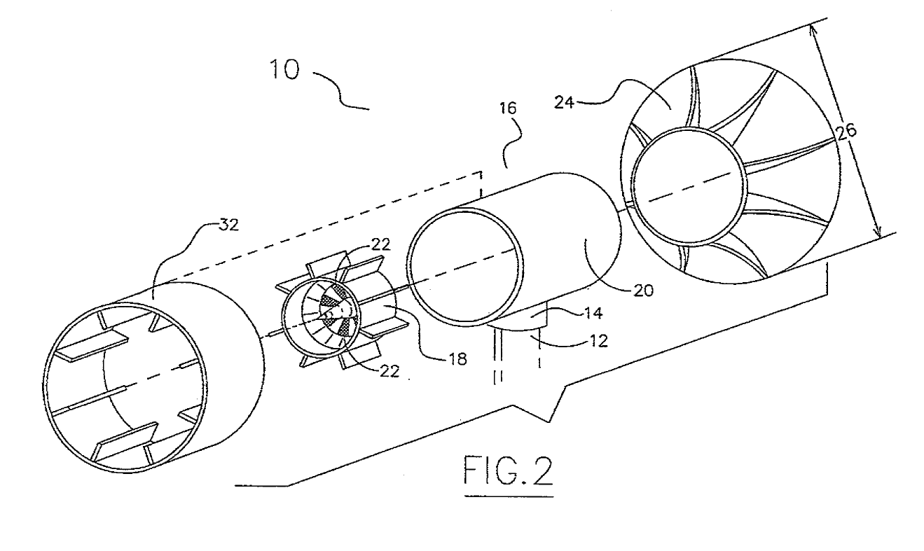

FIG. 2 illustrates that, in one preferred embodiment, sleeve 14 is connected to a wind turbine assembly 16 comprised of a wind turbine 18 disposed within a housing/shroud 20.

One may use any of the wind turbine assemblies 16 known to those skilled in the art. Thus, e.g., and by way of illustration and not limitation, one may use the wind turbine assemblies disclosed in U.S. Pat. Nos. 4,021,135 (wind turbine), 4,075,500 (variable stator diffuser augmented wind turbine electrical generation system), 4,218,175 (wind turbine), 4,285,481 (multiple wind turbine tethered airfoil wind energy conversion system), 4,324,985 (portable wind turbine for charging batteries), 4,482,290 (diffuser for augmenting a wind turbine), 4,684,316 (improvements in wind turbine having a wing-profiled diffuser), 4,915,580 (wind turbine runner impulse type), 6,493,743 (jet assisted hybrid wind turbine system), 6,638,005 (coaxial wind turbine apparatus having a closeable air inlet opening), 7,218,011 (diffuser augmented wind turbine), 7,230,348 (infuser augmented wind turbine electrical generating system), and the like. The entire disclosure of each of these United States patents is hereby incorporated by reference into this specification.

In one embodiment, one may use one or more of the wind turbine assemblies disclosed in applicant's U.S. Pat. No. 6,655,907, the entire disclosure of which is hereby incorporated by reference into this specification. Claim 1 of this patent describes: “1. A fluid-driven power generator comprised of a turbine comprised of a multiplicity of vanes, wherein said turbine is within a housing assembly, and wherein said housing assembly is comprised of an exhaust chamber, means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber, wherein: (a) said means for directing fluid towards said tangential portions of said turbine comprises a first interior sidewall, and a second interior sidewall connected to said first sidewall, and (b) said means for directing fluid towards said tangential portions of said turbine is comprised of means for causing said fluid to flow around said turbine and, for at least about 120 degrees of said flow of said fluid around said turbine, for constricting said fluid and increasing its pressure.”

In one embodiment, the turbine 16 is an axial flow wind turbine. These wind turbines are well known and are described, e.g., in the claims of U.S. Pat. No. 6,223,558, the entire disclosure of which is hereby incorporated by reference into this specification.

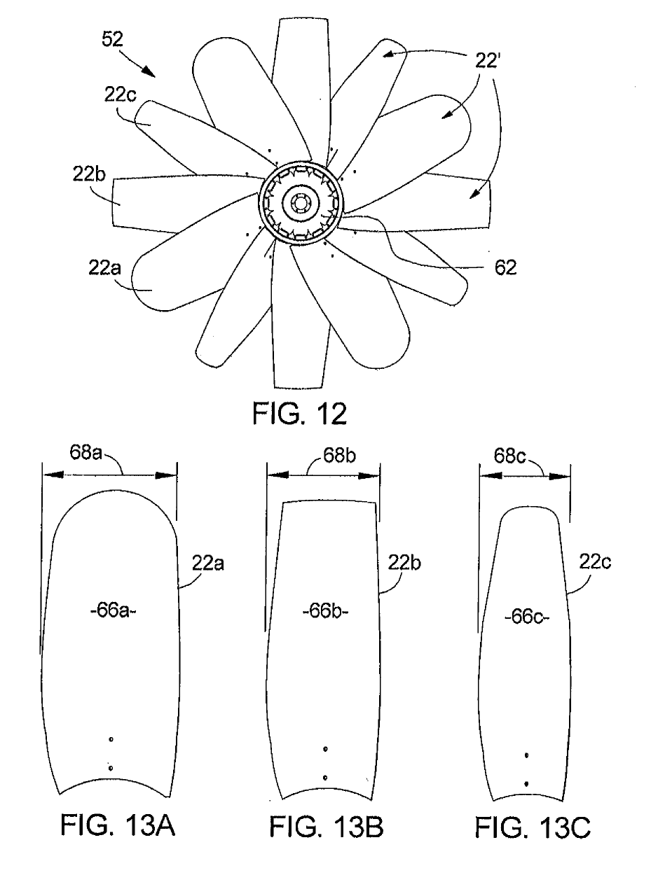

The axial flow wind turbine 16 is comprised of a multiplicity of wind turbine blades 22 disposed within housing/shroud. In one embodiment, the turbine blades used in wind turbine 16 may be those that are well known to those skilled in the art. Reference may be had, e.g., to U.S. Pat. Nos. 3,425,665 (gas turbine rotor blade shroud), 3,656,863 (transpiration cooled turbine rotor blade), 3,902,820 (fluid cooled turbine rotor blade), 4,066,384 (turbine rotor blade having integral tenon thereon and split shroud ring associated therewith), 4,424,002 (tip structure for cooled turbine rotor blade), 4,480,956 (turbine rotor blade for a turbomachine), 4,056,639 (axial flow turbine blade), 4,784,569 (shroud means for turbine rotor blade tip clearance control), 4,976,587 (composite wind turbine rotor blade), 5,059,095 (turbine rotor blade coated with alumina-zirconia ceramic), 5,474,425 (wind turbine rotor blade), 5,660,527 (wind turbine rotor blade root end), 6,877,955 (mixed flow turbine rotor blade), 6,966,758 (wind turbine rotor blade comprising one or more means secured to the blade for changing the profile thereof depending on the atmospheric temperature), 7,063,508 (turbine rotor blade), and the like. The entire disclosure of each of these United States patents is hereby incorporated by reference into this specification. As best seen in FIGS. 12, 13A, 13B, and 13C, the wind turbine 16 may also include a plurality of different sized wind turbine blades 22′, which will be described in more detail below.

Referring to FIGS. 1-3, it will be seen that, in the embodiment depicted, shroud 20 is connected to a diffuser 24. The diffuser 24 in the embodiment depicted, has a maximum cross-sectional dimension 26 that is substantially larger than the diameter of shroud 20. These (and other) diffusers are well known and are described, e.g., in U.S. Pat. Nos. 3,364,678 (turbine radial diffuser), 3,978,664 (gas turbine engine diffuser), 4,075,500 (variable stator, diffuser augmented wind turbine electrical generation system), 4,177,638 (single shaft gas turbine engine with radial exhaust diffuser), 4,422,820 (spoiler for fluid turbine diffuser), 4,458,479 (diffuser for gas turbine engine), 4,482,290 (diffuser for augmenting a wind turbine), 4,503,668 (strutless diffuser for a gas turbine engine), 4,527,386 (diffuser for gas turbine engine), 5,462,088 (gas turbine exhaust diffuser), 5,704,211 (gas turbine engine with radial diffuser), 6,488,470 (annular flow diffusers for gas turbines), 6,866,479 (exhaust diffuser for axial flow turbine), 7,114,255 (method of making a gas turbine engine diffuser), 7,218,011 (diffuser augmented wind turbine), and the like. The entire disclosure of each of these United States is hereby incorporated by reference into this specification.

As will be apparent, the combination of the wind turbine assembly 16 (comprised of the shroud 20 and its associated structure) and the diffuser 24 comprises a diffuser augmented wind turbine assembly.

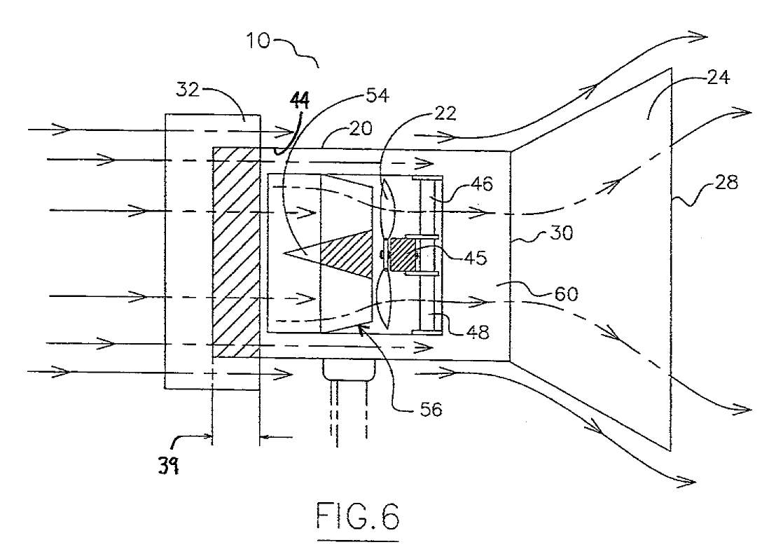

FIG. 6 is a plan sectional viewing better illustrating the relationship between diffuser 24 and shroud 20. In the embodiment depicted, it will be seen that the maximum dimension 26 (FIG. 2) of the diffuser 24 occurs at its outlet 28, and that such maximum dimension 26 is greater than the maximum dimension of shroud 20 occurs, in the embodiment depicted, at the outlet 30 of such shroud. The dimension 26 is at least about 1.5 times as great as maximum dimension of shroud 20 and, and, preferably, is at least 2.0 times as great as maximum dimension of shroud 20. In one embodiment, the dimension 26 is at least about 2.5 times as great as the maximum dimension of shroud 20.

Referring again to FIG. 6, and to the embodiment depicted therein, it will be seen that shroud 20 may be partially disposed within a wind inlet suppressor assembly 32.

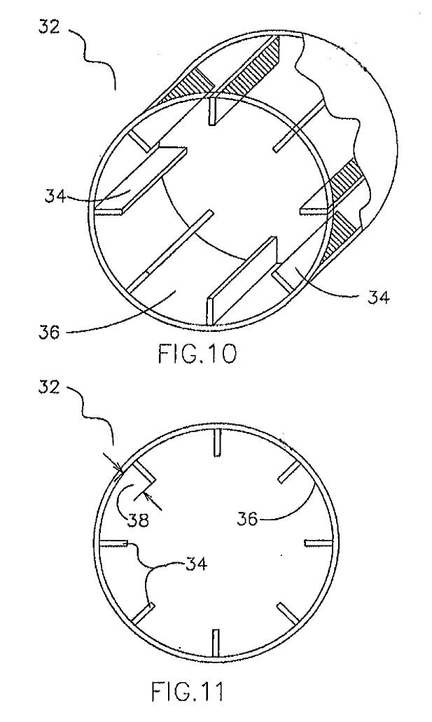

FIG. 10 is a sectional perspective view of wind inlet suppressor assembly 32, and FIG. 11 is a front view of suppressor assembly 32. In the embodiment, depicted, suppressor assembly 32 is comprised of a multiplicity of vanes 34.

The vanes 34, in one embodiment, are integrally joined to the interior surface 36 of the wind inlet suppressor assembly 32. In one embodiment, each of such vanes is substantially perpendicular to such interior surface 36.

In the embodiment, each of the vanes 34 has a length 38 that is from 2 to about 20 percent of the total internal diameter of the suppressor. As will be seen from the embodiment depicted in, e.g., FIG. 1, the vanes extend from interior surface 36 until they are substantially contiguous with the shroud 20.

Referring again to FIGS. 10 and 11, it will be seen that vanes 34 are disposed substantially equidistantly around the interior surface 36.

Referring again to FIG. 1, and to the embodiment depicted therein, it will be seen that shroud 20 is within the suppressor assembly 32. This is also shown, e.g., in FIG. 2.

Referring to FIG. 6, and to the embodiment depicted therein, it will be seen that shroud 20 is only partially disposed within the suppressor assembly 32. In the embodiment depicted in FIG. 6, the shroud 20 extends within the suppressor assembly 32 a distance 39 that often is from about 6 inches to about 1 foot. As will be apparent, the distance 39 varies depending upon the dimensions of the components of the overall assembly.

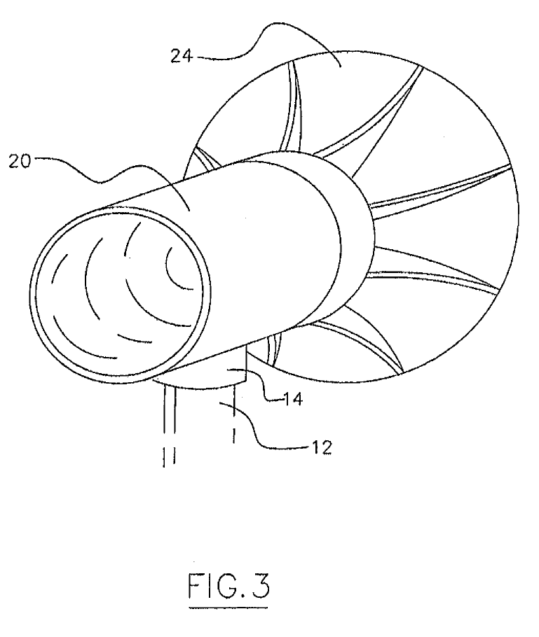

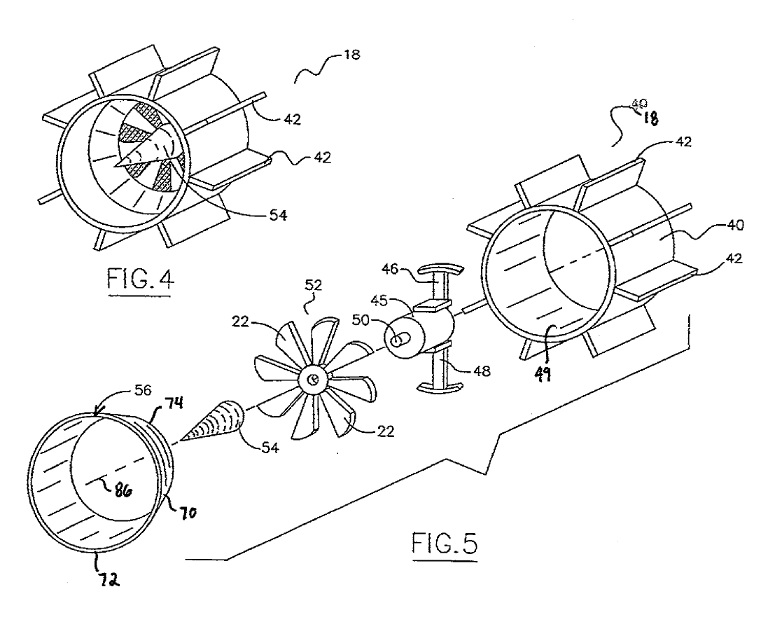

FIG. 2 is an exploded view of assembly 10 illustrating how shroud 20 is disposed within assembly 32, and how turbine assembly 18 is disposed within shroud 20. The wind turbine assembly 18 is illustrated in greater detail in FIGS. 4 and 5.

Referring to FIGS. 4 and 5, it will be seen that wind turbine assembly 18 is comprised of a housing 40. Such housing 40 is comprised of a multiplicity of vanes 42 that are contiguous with the inner surface 44 (FIG. 1) of shroud 20.

Disposed within housing 40 is a generator 45 that is connected by mounts 46 and 48 to the interior surface 49 of the housing 40. As axle 50 is rotated, it causes electricity to be generated in generator 45. The electricity so produced is delivered by conventional means (not shown) to a desired end use.

Referring again to FIG. 5, it will be seen that a rotor 52 is rotatably mounted on axle 50. As air (not shown) passes over blades 22, it causes them to move in an axial direction and to cause the rotation of axle 50.

In the embodiment depicted in FIG. 5, a cone diffuser 54 is mounted on rotor 52 aid in directing air past the blades 22.

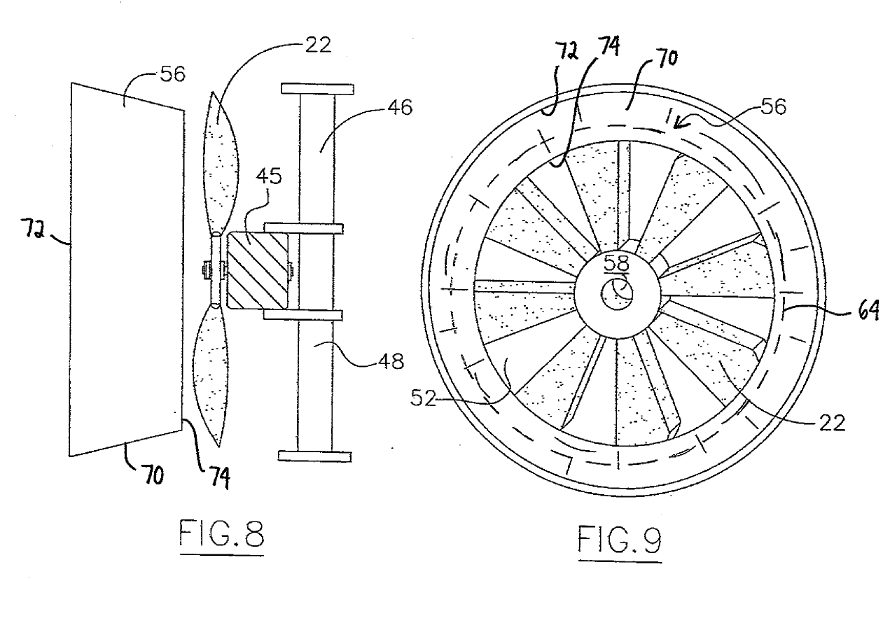

In another embodiment, as best seen in FIG. 12, an improved rotor 52′ may be used in assembly 10, which includes a plurality of blades 22′ that are coupled with, and radially extend from, a hub 62. In particular, the plurality of blades 22′ includes different sized blades 22a, 22b, 22c having different surface areas relative to a swept area 64 (FIG. 9) of rotor 52′ as it rotates about axle 50 (FIG. 5). The swept area 64 is the area that the blades of a rotor pass through when rotating about its axis. As outlined in dotted lines in FIG. 5, swept area 64 is shown as being circular-shaped. Providing a rotor 52′ having blades 22a, 22b, 22c with different surface areas will allow the assembly 10 to operate more efficiently in light, medium and heavy winds (i.e., variable speed winds).

For example, rotor 52′ is shown in FIG. 12 as including three different sized blades 22a, 22b, 22c radially extending from hub 62. Blades 22a are shown as being spaced equally about hub 62, blades 22b are equally spaced about hub 62, and blades 22c are equally spaced about hub 62. Therefore, if the rotor 52′ includes four blades 22a, then each of the blades 22a would be spaced ninety-degrees apart from one another, which would also apply to blades 22b and 22c. However, it should be understood that the blade 22′ size configuration may either provide for either equal or non-equal spacing around hub 62, so long as there is equal weight distribution about hub 62.

As best seen in FIGS. 13A, 13B and 13C, each of the blades 22a, 22b, 22c include different surface areas 66a, 66b, 66c, wherein blade 22a has the largest relative surface area 66a and blade 22c has the smallest relative surface area 66c, with blade 22b having a surface area 66b in between surface areas 66a, 66c. Another way to describe the relative size of each of the blades 22a, 22b, 22c is to do so based on a maximum width of the blades. In this context, blade 22a has the largest relative maximum width 68a and blade 22c has the smallest relative maximum width 68c, with blade 22b having a maximum width 68b in between maximum widths 68a, 68c.

A blade with a larger surface area will cause a rotor to rotate faster in a light wind compared to a blade with a smaller surface area. In contrast, a blade with a smaller surface area will cause a rotor to rotate more efficiently in a heavy wind compared to a blade with a larger surface area. Thus, in the exemplary configuration disclosed herein, blades 22a would allow assembly 10 to operate efficiently in light winds, blades 22c would allow assembly to operate efficiently in high winds, and blades 22b would allow assembly to operate efficiently in medium winds.

It should be understood that while there are three different sized blades used in improved rotor 52′, it should be understood that the present invention also includes the use of two different sized blades radially disposed about hub 62, as well as four or more different sized blades radially disposed about hub 62.

In the embodiment depicted in FIG. 5, a vorticity reducing cowling 56 is disposed in front of, or upstream of, rotor 52 to reduce the rotor blade tip vorticity. In addition, cowling 56 may also be positioned in front of rotor 52′. As is known to those skilled in the art, vorticity, for fluid flow, is a vector equal to the curl of the velocity of flow. Reference may be had, e.g., to U.S. Pat. Nos. 4,145,921 (vorticity probe), 4,344,394 (piston engine using optimizable vorticity), 4,727,751 (crossflow vorticity sensor), 5,100,085 (airtip wingtip vorticity redistribution apparatus), 5,222,455 (ship wake vorticity suppressor), 6,507,793 (method for measuring vorticity), 7,134,631 (vorticity cancellation at trailing edge for induced drag elimination), 7,241,113 (vorticity control in a gas turbine engine), and the like; the entire disclosure of each of these United States patents is hereby incorporated by reference into this specification.

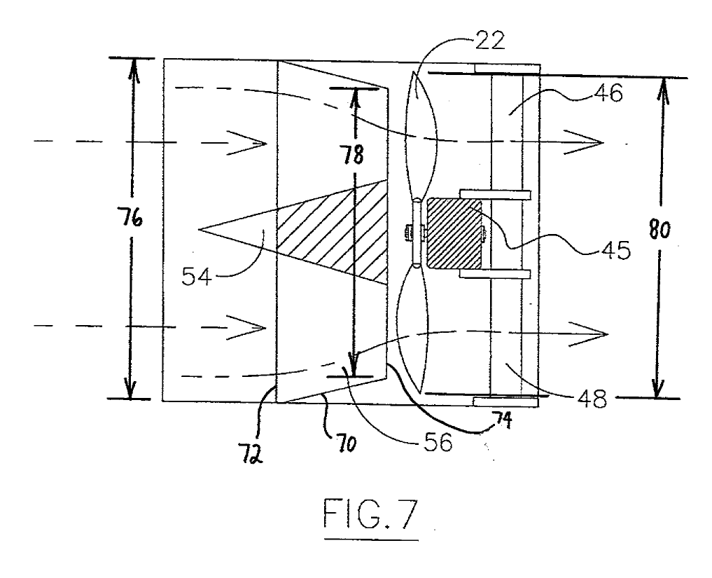

Referring again to FIGS. 5-9, the cowling 56 is adapted to reduce the vorticity of the fluid flowing onto and past blades 22, 22′. Cowling 56 includes a tapered body 70 including an inlet end 72 defining an inlet opening, and an outlet end 74 defining an outlet opening. The inlet opening has a flow area that is greater than a flow area of second opening, whereby the fluid is compressed as it flows through cowling 56 toward blades 22, 22′ thereby extracting more energy from the incoming fluid. Furthermore, in order to reduce the vorticity of the fluid flowing onto and past blades 22, 22′, the flow area of the outlet opening is less than the swept area 64. For example, the flow areas of the inlet and outlet openings, as well as the swept area, may all be circular-shaped. Therefore, as best seen in FIG. 7, the inlet opening, the outlet opening and the swept area include a diameter 76, 78, 80, wherein the diameter 78 of the outlet opening is less than the diameter 80 of swept area 64. In addition, the circular outlet opening may be concentrically positioned relative to the circular swept area 64 so that all of the compressed fluid flowing through outlet opening of cowling 56 is directed to blades 22, 22′, as opposed to allowing some of the fluid to flow around the tip of the blades 22, 22′. Moreover, by directing the fluid away from the tips of the blades 22, 22′ by using an outlet opening diameter 78 that is less than the diameter 80 of the swept area 64, in the area between diameters 78, 80, the blade tips operate in an enhanced vacuum thereby reducing the drag imposed on the blades 22, 22′.

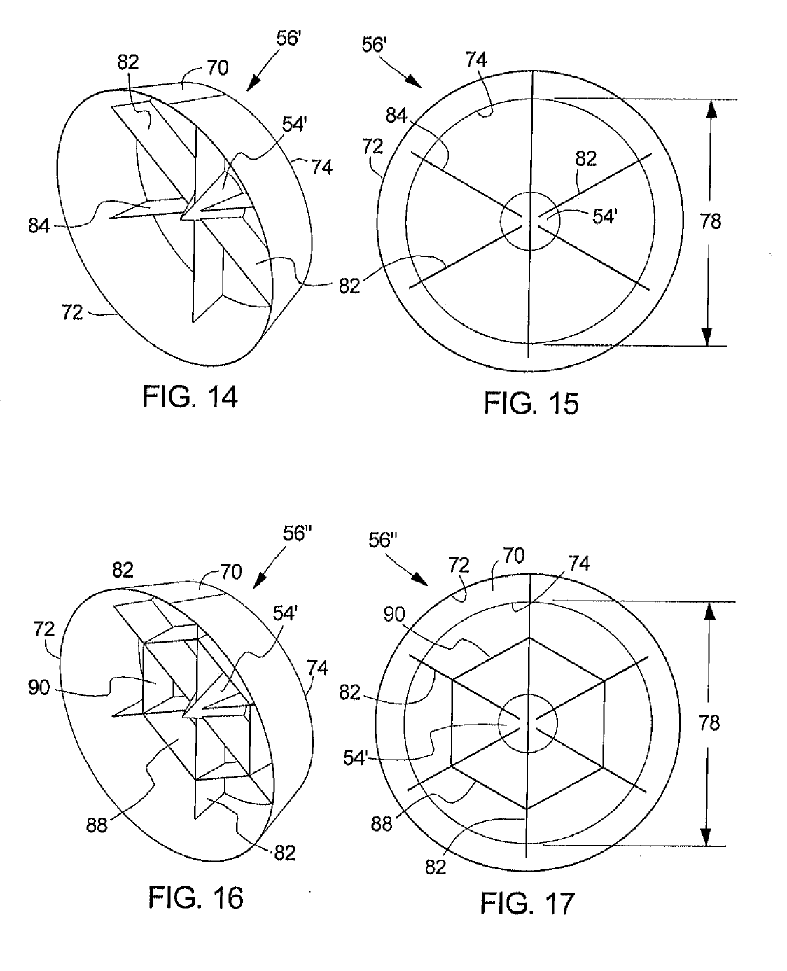

The cowling 56 described above may also be replaced with the cowling 56′ shown in FIGS. 14 and 15. All of the features and aspects described above with respect to cowling 56 also apply to cowling 56′, and need not be repeated. However, cowling 56′ further includes a plurality of radially disposed stator members 82 that may be directed inwardly toward the geometric center of body 70. Each of stator members 82 may be planar having a flat surface area 84 that is oriented parallel with a longitudinal axis 86 (FIG. 2) of wind turbine 18. The stator members 82 may be integrally formed with body 70 or separately attached thereto. The stator members 82 operate to provide structural support for the body 70 of cowling 56′ to maintain its shape, as well as assist in directing the fluid to the blades 22, 22′ and providing a laminar flow of fluid to the blades 22, 22′.

In addition, a cone diffuser 54′, similar to the one shown in FIG. 5, may be disposed on longitudinal axis 86 and integrally formed with one or more of the stator members 82. In conjunction with the inwardly tapered body 70, cone diffuser 54 operates to direct fluid flowing through cowling 56′ toward the blades 22, 22′, thereby further enhancing the compression of the fluid passing to the blades 22, 22′. While the diffuser 54′ is shown as being cone-shaped, it should also be understood that diffuser may take the form of a open-ended cylinder.

The cowlings 56, 56′ described above may also take the form of the cowling 56″ shown in FIGS. 16 and 17. In addition to the features described with respect to cowling 56′, cowling 56″ further includes a plurality of lateral stator members 88 that are each coupled between two of the radial stator members 82. Specifically, each of lateral stator members 88 may be coupled with a midpoint of both radial stator members 82. As with the radial stator members 82, lateral stator members 88 may be planar having a flat surface area 90 that is oriented parallel with longitudinal axis 86 (FIG. 2) of wind turbine 18. As best seen in FIG. 17, the plurality of lateral stator members 88 may form a hexagon configuration. The lateral stator members 88, in conjunction with radial stator members 82, operate to provide structural support for the body 70 of cowling 56″ to maintain its shape, as well as assist in directing the fluid to the blades 22, 22′ and providing a laminar flow of fluid to the blades 22, 22′.

FIG. 9 illustrates how the rotor 52 is preferably disposed behind cowling 56. As will be apparent, the axle 50 of generator 45 is connected to axle receptacle 58.

In U.S. Pat. No. 6,655,907, the entire disclosure of which is hereby incorporated by reference into this specification, claim 1 discloses: “1. A fluid-driven power generator comprised of a turbine comprised of a multiplicity of vanes, wherein said turbine is within a housing assembly, and wherein said housing assembly is comprised of an exhaust chamber, means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber, wherein: (a) said means for directing fluid towards said tangential portions of said turbine comprises a first interior sidewall, and a second interior sidewall connected to said first sidewall, and (b) said means for directing fluid towards said tangential portions of said turbine is comprised of means for causing said fluid to flow around said turbine and, for at least about 120 degrees of said flow of said fluid around said turbine, for constricting said fluid and increasing its pressure.”

Referring to FIGS. 6 and 7, and in the embodiment depicted therein, the device illustrated also creates a vacuum in an exhaust chamber.

Referring to FIG. 6, some of the wind flowing into the wind inlet suppressor 32 bypasses the interior 44 of shroud 20, while other of such wind flows through the interior of shroud 20. These two wind currents mix behind the rotor blades 22 in, e.g., chamber 60 of shroud 20. The two wind currents may also mix, e.g., within diffuser 24. As will be apparent to those skilled in the art, by the particular combination of elements used in applicant's device, there is provided “means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber . . . ”

U.S. Pat. No. 6,655,907 describes particular “means for directing a first fluid towards said vanes of said turbine, means for directing a second fluid through said housing assembly without contacting said turbine, means for combining said first fluid and said second fluid in said exhaust chamber, and means for creating a vacuum in said exhaust chamber . . . ” Any of these means may also be used in the apparatus 10 of the present invention.

Thus, e.g., one may use the structure described in claim 2 of such patent, which discloses “2. The power generator as recited in claim 1, wherein said means for creating a vacuum in said exhaust chamber is comprised of a movable vacuum flap disposed in said exhaust chamber.”

Thus, e.g., one may use the structure described in claim 3 of such patent, which discloses: “3. The power generator as recited in claim 2, wherein said housing is comprised of an air flow diverter.”

Thus, e.g., one may use the structure described in claim 4 of such patent, which discloses: “4. The power generators as recited in claim 3, wherein said vacuum flap is pivotally connected to said air flow diverter.”

Thus, e.g., one may use the structure described in claim 5 of such patent, which discloses: “5. The power generator as recited in claim 4, wherein said exhaust chamber is comprised of a constant area section and a varying area section.”

The entire disclosure of such U.S. Pat. No. 6,655,907 is hereby incorporated by reference into this specification.

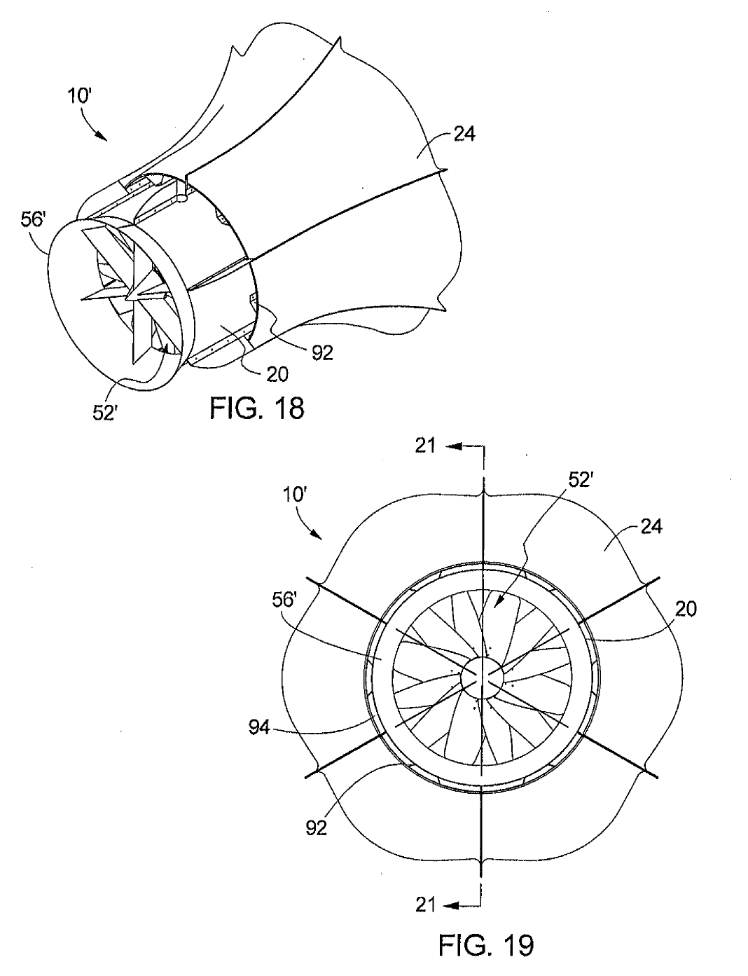

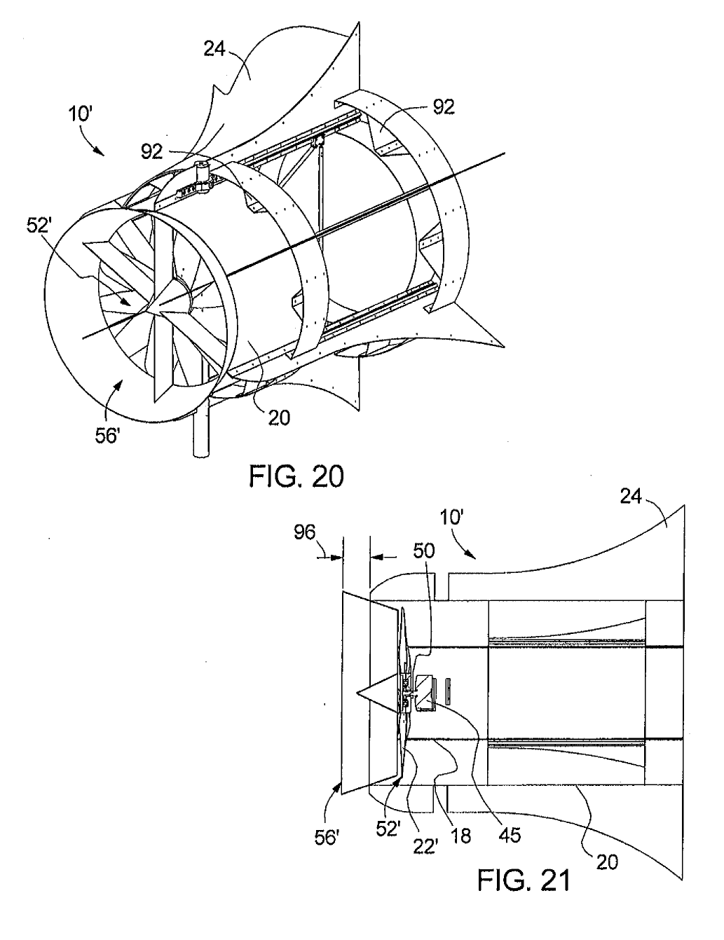

As best seen in FIGS. 18-21, cowling 56′ may be used in conjunction with a diffuser augmented wind turbine assembly 10′. As with assembly 10, assembly 10′ includes a diffuser 24 coupled to an outlet end of shroud 20. Assembly 10′ includes a plurality of spacers 92 that operate to couple diffuser 24 to shroud 20 in a spaced apart manner, thereby defining a bypass passage 94 between an outer surface of shroud 20 and an inner surface of diffuser 24. Mounts 46, 48 (FIG. 5) are used fasten the generator 45 and axle 50 within the wind turbine 18, and rotor 52′ is rotatably mounted to axle 50.

As best seen in FIG. 21, cowling 56′ is mounted to shroud 20 upstream of rotor 52′ and operates to compress the fluid flowing to the plurality of blades 22′, while reducing the vorticity of the fluid flowing onto and past blades 22′. It should be understood that cowling 56′ need not be disposed entirely within shroud 20. For example, as best seen in FIG. 21, a first portion of cowling 56′ can be disposed within shroud 20, and a second portion of cowling 56′ may extend outwardly beyond an inlet end of shroud 20 a distance 96 of about 8 inches to about 14 inches. It should be understood that the distance 96 could be more than 14 inches or less than 8 inches depending on the size and design of assembly 10′. It can be seen in FIG. 21 that the diameter of the inlet opening of the shroud is less than the diameter of the inlet opening of the cowling 56′. While cowling 56′ is being shown in conjunction with assembly 10′, it should be understood that cowling 56 and cowling 56″ could be used with assembly 10′ as well. Also, rotor 52 may be used in assembly 10′ instead of rotor 52′.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A vorticity reducing cowling for a diffuser augmented wind turbine assembly, the diffuser augmented wind turbine assembly including a shroud, a wind turbine disposed within the shroud, and a diffuser coupled to an outlet of the shroud, the wind turbine including a wind turbine housing and a plurality of blades rotatably disposed within the wind turbine housing, the plurality of blades providing a swept area, the cowling comprising:
a body disposed upstream of the plurality of blades;
said body including an inlet end defining a first opening, said first opening having a first area; and
said body including an outlet end defining a second opening, said second opening having a second area that is less that said first area, wherein said second area is less than the swept area of the plurality of the blades.

2. A vorticity reducing cowling in accordance with claim 1, wherein said second opening is circular and has a diameter, wherein the swept area is circular and has a diameter, and wherein said diameter of said second opening is less than the diameter of the swept area.

3. A vorticity reducing cowling in accordance with claim 2, wherein said diameter of said second opening and the diameter of the swept area are concentrically disposed relative to one another.

4. A vorticity reducing cowling in accordance with claim 1, further comprising a plurality of radially disposed stator members coupled with said body.

5. A vorticity reducing cowling in accordance with claim 4, wherein said radial stator members are planar.

6. A vorticity reducing cowling in accordance with claim 5, wherein said radial stator members are disposed parallel with a longitudinal axis of the wind turbine.

7. A vorticity reducing cowling in accordance with claim 4, wherein said radial stator members are integrally formed with said body.

8. A vorticity reducing cowling in accordance with claim 4, further comprising a cone diffuser coupled with said radial stator members.

9. A vorticity reducing cowling in accordance with claim 8, wherein said cone diffuser is disposed on a longitudinal axis of the wind turbine.

10. A vorticity reducing cowling in accordance with claim 4, further comprising at least one lateral stator member that is coupled to two of said radial stator members.

11. A vorticity reducing cowling in accordance with claim 10, wherein said at least one lateral stator member is coupled to a midpoint of said radial stator members.

12. A vorticity reducing cowling in accordance with claim 10, wherein said at least one lateral stator member is planar and parallel with a longitudinal axis of the wind turbine.

13. A vorticity reducing cowling in accordance with claim 4, further comprising a plurality of lateral stator members coupled to said radial stator members, wherein said plurality of lateral stator members form a hexagon.

14. A vorticity reducing cowling in accordance with claim 1, further comprising:
a plurality of radially disposed stator members coupled with said body;
a cone diffuser coupled with said radially disposed stator members; and
a plurality of lateral stator members coupled to said radially disposed stator members.

15. A diffuser augmented wind turbine assembly comprising:
a shroud including an inlet end and an outlet end;
a plurality of blades rotatably disposed within said shroud, the plurality of blades providing a swept area;
a diffuser coupled to said outlet end of said shroud; and
a cowling coupled with said inlet end of said shroud, said cowling comprising:
a body disposed upstream of said plurality of blades;
said body including an inlet end defining a first opening, said first opening having a first area; and
said body including an outlet end defining a second opening, said second opening having a second area that is less that said first area, wherein said second area is less than said swept area of said plurality of said blades.

16. A diffuser augmented wind turbine assembly in accordance with claim 15, further comprising a plurality of radially disposed stator members coupled with said body.

17. A diffuser augmented wind turbine assembly in accordance with claim 16, further comprising a cone diffuser coupled with said radially disposed stator members.

18. A diffuser augmented wind turbine assembly in accordance with claim 16, further comprising a plurality of lateral stator members coupled to said radially disposed stator members.

19. A diffuser augmented wind turbine assembly in accordance with claim 16, wherein a first portion of said body is disposed within said shroud, and a second portion of said body extends outwardly from said inlet end of said shroud.

20. A diffuser augmented wind turbine assembly in accordance with claim 16, wherein said shroud includes an exhaust chamber, and wherein the diffuser augmented wind turbine assembly includes means for directing a first fluid towards said plurality of blades, means for directing a second fluid around said shroud without contacting said plurality of blades, means for combining said first fluid and said second fluid in said exhaust chamber, and means for creating a vacuum in said exhaust chamber.

21. A diffuser augmented wind turbine assembly comprising:
a shroud including an outlet end;
a wind turbine disposed within said shroud, said wind turbine including a wind turbine housing and a plurality of blades rotatably disposed within said wind turbine housing, the plurality of blades providing a swept area;
a diffuser coupled to said outlet end of said shroud; and
a cowling coupled with said wind turbine assembly, said cowling comprising:
a body disposed upstream of said plurality of blades;
said body including an inlet end defining a first opening, said first opening having a first area; and
said body including an outlet end defining a second opening, said second opening having a second area that is less that said first area, wherein said second area is less than said swept area of said plurality of said blades.

22. A diffuser augmented wind turbine assembly in accordance with claim 21, further comprising a plurality of radially disposed stator members coupled with said body.

23. A diffuser augmented wind turbine assembly in accordance with claim 22, further comprising a cone diffuser coupled with said radially disposed stator members.

24. A diffuser augmented wind turbine assembly in accordance with claim 22, further comprising a plurality of lateral stator members coupled to said radially disposed stator members.

25. A diffuser augmented wind turbine assembly in accordance with claim 22, wherein said shroud includes an exhaust chamber, and wherein the diffuser augmented wind turbine assembly includes means for directing a first fluid towards said plurality of blades, means for directing a second fluid through said shroud without contacting said plurality of blades, means for combining said first fluid and said second fluid in said exhaust chamber, and means for creating a vacuum in said exhaust chamber.
